(19) United States
(12) Patent Application Publication
(10) Pub. No.: US 2019/0382235 A1
(43) Pub. Date: Dec. 19, 2019

(54) ELEVATOR SCHEDULING SYSTEMS AND METHODS OF OPERATION

(71) Applicant: Otis Elevator Company, Farmington, CT (US)

(72) Inventors: Derk Oscar Pahlke, Berlin (DE); Arthur Hsu, South Glastonbury, CT (US); Stephen Richard Nichols, Plantsville, CT (US)

(21) Appl. No.: 16/009,417

(22) Filed: Jun. 15, 2018

(51) Int. Cl. B66B 1/46; B66B 1/34; B66B 1/28; B66B 9/00

(52) U.S. Cl. CPC B66B 1/468; B66B 1/3461; B66B 1/28; B66B 2201/101; B66B 2201/4653; B66B 2201/4638; B66B 2201/402; B66B 9/00

(57) ABSTRACT

Methods and systems for controlling elevators are provided. The methods include at least one of receiving and determining, at an elevator system computing device, a call probability associated with at least one of a movement, a position, a speed, and a direction of a user of the elevator system, scheduling, with a dispatching system, an elevator car operation based on at least the call probability, and controlling, with an elevator controller, the operation of an elevator car based on the scheduled elevator car operation.

### BACKGROUND

The subject matter disclosed herein generally relates to elevator systems and, more particularly, to elevator scheduling systems and systems and methods for dispatching elevator cars.

Elevators are provided with user interfaces to enable passengers to access and use the elevator (e.g., to call elevator cars to travel to different floors within a building). One type of such user interface is a hall call panel that may be a user interface device (e.g., operating panel) located proximate an elevator landing door in a hallway, lobby, or landing of an elevator system. The hall call panels are interactive and may provide information to potential passengers (e.g., indicating that an elevator car has already been called).

Although hall call panels are traditionally provided, waiting until a user of the elevator system reaches the elevator system and interacts with the hall call panel may be inefficient, and require long wait times for users. Further, such call request entries may reduce efficiencies of the elevator system and scheduling thereof because the calls may not be anticipated and scheduling efficiencies may be reduced. Accordingly, it may be advantageous to increase elevator scheduling efficiencies.

### SUMMARY

According to some embodiments, methods for controlling elevator systems are provided. The methods include at least one of receiving and determining, at an elevator system computing device, a call probability associated with at least one of a movement, a position, a speed, and a direction of a user of the elevator system, scheduling, with a dispatching system, an elevator car operation based on at least the call probability, and controlling, with an elevator controller, the operation of an elevator car based on the scheduled elevator car operation.

In addition to one or more of the features described above, or as an alternative, further embodiments of the methods may include that the call probability is determined at a user device and transmitted to the elevator computing device.

In addition to one or more of the features described above, or as an alternative, further embodiments of the methods may include that the call probability is based on information obtained on the user device.

In addition to one or more of the features described above, or as an alternative, further embodiments of the methods may include sensing at least one of the position and the movement of the user using at least one sensor arranged within a building containing the elevator system and transmitting sensed information to the dispatching system.

In addition to one or more of the features described above, or as an alternative, further embodiments of the methods may include generating an elevator call for the user based on the call probability.

In addition to one or more of the features described above, or as an alternative, further embodiments of the methods may include performing machine learning and tracking of user movement pattern information of the user to determine the call probability.

In addition to one or more of the features described above, or as an alternative, further embodiments of the methods may include at least one of receiving and determining a call probability associated with at least one of a movement and a position of at least one additional user of the elevator system.

According to some embodiments, elevator systems are provided. The elevator systems include an elevator car, a plurality of landings, and an elevator scheduling system. The elevator scheduling system includes a processor and memory. The elevator scheduling system is configured to at least one of generate and receive a call probability associated with at least one of a movement, a position, a speed, and a direction of a user of the elevator system, schedule an elevator car operation based on at least the call probability, and control the operation of an elevator car based on the scheduled elevator car operation.

In addition to one or more of the features described above, or as an alternative, further embodiments of the elevator systems may include that the call probability is determined at a user device and transmitted to the elevator scheduling system.

In addition to one or more of the features described above, or as an alternative, further embodiments of the elevator systems may include that the call probability is based on information obtained on the user device.

In addition to one or more of the features described above, or as an alternative, further embodiments of the elevator systems may include at least one sensor arranged within a building containing the elevator system, the at least one sensor configured to detect at least one of the position and the movement of the user, wherein the at least one sensor is in communication with the elevator scheduling system.

In addition to one or more of the features described above, or as an alternative, further embodiments of the elevator systems may include that the scheduling system is further configured to generate an elevator call for the user based on the call probability.

In addition to one or more of the features described above, or as an alternative, further embodiments of the elevator systems may include that the scheduling system is configured to perform machine learning and tracking of user movement pattern information of the user to determine the call probability.

In addition to one or more of the features described above, or as an alternative, further embodiments of the elevator systems may include that the scheduling system is further configured to at least one of receive and determine a call probability associated with at least one of a movement and a position of at least one additional user of the elevator system.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the present disclosure;

FIG. 2 is a schematic block diagram illustrating a computing system that may be employed by an embodiment of the present disclosure;

FIG. 3 illustrates a schematic block diagram of a system configured in accordance with an embodiment of the present disclosure;

FIG. 4 is a schematic illustration of a system in accordance with an embodiment of the present disclosure; and

FIG. 5 is a flow process in accordance with an embodiment of the present disclosure.

### DETAILED DESCRIPTION

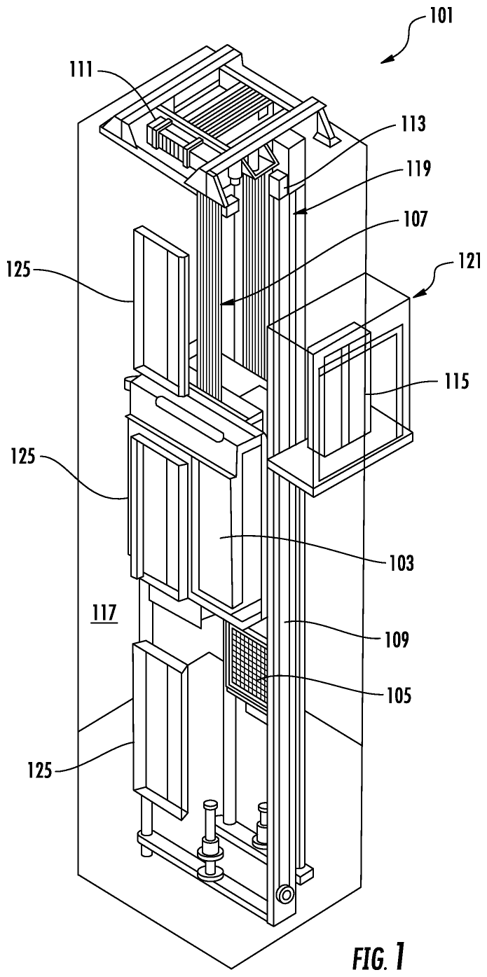

FIG. 1 is a perspective view of an elevator system 101 including an elevator car 103, a counterweight 105, a roping 107, a guide rail 109, a machine 111, a position encoder 113, and an elevator controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The elevator controller 115 is located, as shown, in a controller room 121 of the elevator shaft 117 and is configured to control the operation of the elevator system 101, and particularly the elevator car 103. For example, the elevator controller 115 may provide drive signals to the machine 111 to control the acceleration, deceleration, leveling, stopping, etc. of the elevator car 103. The elevator controller 115 may also be configured to receive position signals from the position encoder 113. When moving up or down within the elevator shaft 117 along guide rail 109, the elevator car 103 may stop at one or more landings 125 as controlled by the elevator controller 115. Although shown in a controller room 121, those of skill in the art will appreciate that the elevator controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes.

Referring now to FIG. 2, an exemplary computing system 200 is shown. The computing system 200 may be configured as part of and/or in communication with an elevator controller, e.g., controller 115 shown in FIG. 1. The computing system 200 is configured to perform the processes and procedures as described herein. The computing system 200 includes a memory 202 which may store executable instructions and/or data. The executable instructions may be stored or organized in any manner and at any level of abstraction, such as in connection with one or more applications, processes, routines, procedures, methods, etc. As an example, at least a portion of the instructions are shown in FIG. 2 as being associated with a program 204. Further, as noted, the memory 202 may store data 206. The data 206 may include profile or registration data, elevator car data, device identifier data, or any other type(s) of data. The instructions stored in the memory 202 may be executed by one or more processors, such as a processor 208. The processor 208 may be operative on the data 206.

The processor 208 may be coupled to one or more input/output (I/O) devices 210. In some embodiments, the I/O device(s) 210 may include one or more of a keyboard or keypad, a touchscreen or touch panel, a display screen, a microphone, a speaker, a mouse, a button, a remote control, a joystick, a printer, a telephone or mobile device (e.g., a smartphone), a camera, a presence detection device, a sensor, etc. The I/O device(s) 210 may be configured to provide an interface to allow a user to interact with the computing system 200. Additionally, the I/O devices 210 can include one or more sensors that are arranged within a building, as described herein, to provide information to the computing system 200. The sensors may operate and/or communicate through wired or wireless communications, as will be appreciated by those of skill in the art. Data collected or received from the sensors may be processed by the processor 208. In some embodiments, the processor 208 may represent a collection of multiple processors that are configured to operate in concert to achieve the processes and procedures described herein.

The components of the computing system 200 may be operably and/or communicably connected by one or more buses, as known in the art. The computing system 200 may further include other features or components as known in the art. For example, the computing system 200 may include one or more transceivers and/or devices configured to receive information or data from sources external to the computing system 200 (e.g., the sensors noted above). For example, in some embodiments, the computing system 200 may be configured to receive information over a network (wired or wireless). The information received over the network may be stored in the memory 202 (e.g. as data 206) and/or may be processed and/or employed by one or more programs or applications (e.g., program 204).

The computing system 200 may be used to execute or perform embodiments and/or processes described herein. For example, the computing system 200, when configured as part of an elevator control system, may be used to receive commands, data, and/or instructions, and may further be configured to control operation of and/or reservation of elevator cars within one or more elevator shafts.

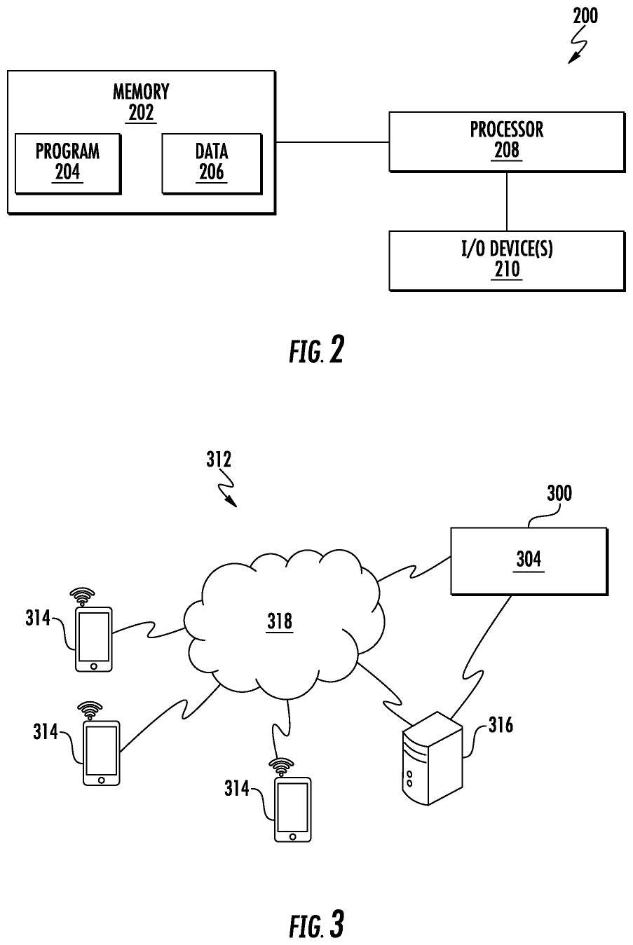

Referring to FIG. 3, a block diagram of an elevator control system 312 for enabling control of an elevator system in accordance with an embodiment of the present disclosure is shown. The elevator control system 312 includes an elevator reservation and control program or application 304 for performing the processing described herein that is executed by one or more computer programs located on a computing system 300 and/or one or more user systems 314, 316. The computing system 300 of FIG. 3 may be configured as a computing system similar to computing system 200 shown in FIG. 2, and may be part of an elevator controller or connected to an elevator controller, as known in the art.

The elevator control system 312 depicted in FIG. 3 includes one or more user systems 314, 316 through which users, e.g., users and passengers of an elevator system, may communicate with the computing system 300 to interact with the elevator system. The user systems 314, 316 are coupled to the computing system 300 via a network 318. Each user system 314, 316 may be implemented using a general-purpose computer executing a computer program for carrying out the processes described herein. The user systems 314, 316 may be user devices such as personal computers (e.g., laptops, tablet computers, cellular telephones, smart phones, wireless handheld devices, etc.) or host attached terminals (e.g., desktop computer). If the user systems 314, 316 are personal computers, in some embodiments, the processing described herein may be shared by a user system 314, 316 and the host system 300. The user systems 314, 316 may also include game consoles, smartphones, tablets, wearable electronic devices, network management devices, and field programmable gate arrays.

The network 318 may be any type of known network including, but not limited to, a wide area network (WAN), a local area network (LAN), a global network (e.g. Internet), a virtual private network (VPN), a cloud network, and an intranet. The network 318 may be implemented using a wireless network or any kind of physical network implementation known in the art. For example, some embodiments may be implemented using global positioning system (GPS), network connections, Wi-Fi connections, Bluetooth® connections, near-field communication connections, etc. A user system 314, 316 may be coupled to the computing system 300 through multiple networks 318 (e.g., cellular and Internet) so that not all user systems 314, 316 are coupled to the computing system 300 through the same network 318. One or more of the user systems 314 and the computing system 300 may be connected to the network 318 in a wireless fashion. As noted, the computing system 300 may be associated with an elevator system (e.g., elevator system 101, and in communication with or part of controller 115 of FIG. 1). The computing system 300 may be used to process, fulfill, and/or automatically generate requests for elevator service, for example, based on information obtained from or regarding the user systems 314, 316.

The requests for elevator service may be received through the network 318 from one or more user devices 314, 316, which may be mobile devices, including, but not limited to phones, laptops, tablets, smartwatches, etc. One or more of the user devices 314 may be associated with (e.g., owned by) a particular user. The user may use his/her user device(s) 314, 316 to request a service, such as an elevator service. Further, an application on the user devices 314, 316 may be configured to automatically transmit information to the computing system 300, such that a passive operation may be employed, rather than relying on direct input or interaction from a user. Further, when one or more sensors detect that a potential passenger has moved near an elevator system, a passive operation may be employed where the sensor data may be transmitted automatically.

In some embodiments of the present disclosure, an elevator call request may be generated in a passive manner based on information obtained from the user devices 314, 316. For example, based on location data of a user, a probabilistic determination regarding an expected elevator call request may be made such that an elevator call request or reservation may be made within an elevator controller or elevator scheduling system. In some embodiments, a profile may be established for the user or the particular user device 314, 316, optionally as part of a registration process with, e.g., a service provider. The profile may contain a log of the user's history and/or activities, such as where the user has gone or traveled to, where the user is scheduled to travel to (e.g., from an appointment calendar), the user's preferences, or any other data that may be applicable to the user. The profile may be accessed or analyzed to determine the likelihood or probability that the user will request elevator service at a particular moment in time (e.g., a particular day or time of day). Resources may be provisioned or allocated to fulfill the request (e.g., an elevator car call or reservation may be placed) in the event that the probability of requested service, or consumption, or use of an elevator is anticipated.

The request for service may be conveyed or transmitted from the user device 314, 316 through the network 318. For example, the request for service may be transmitted to and/or over the Internet and/or a cellular network. The network(s) may include infrastructure that may be organized to facilitate cloud computing. For example, one or more servers, such as a primary message server, a backup message server, and a device commissioning message server may be employed as part of the network 318.

The computing system 300 (and a program 304 stored thereon) may be configured to process information obtained from one or more user devices or other sensors to manage elevator scheduling. As part of the processing, the computing system 300 may validate or authenticate a user device 314, 316 and/or a user, potentially based on an identifier associated with the user and/or the user device 314, 316. The validation may be based on a location of the user and/or the user device 314, 316. The location may be determined based on one or more location-based services or techniques, such as triangulation, global positioning system (GPS), network connection, Wi-Fi connection, proximity to beacons, received signal strength indication (RSSI), etc. In some embodiments, the user may need to be within a threshold distance of a location (e.g., a building) where the requested service (e.g., elevator service) is provided in order for an elevator call request to be processed or generated.

In some embodiments, the computing system 300 may be operably connected to or in communication with one or more additional elements or components. For example, the computing system 300 may be in communication with one or more cameras or other sensors arranged throughout a building. The cameras or other sensors may be arranged to detect the presence of persons on a floor of a building. Accordingly, the computing system 300 may be able to determine the presence of possible passengers, general/specific location(s) of one or more potential passengers, the direction and/or routes of travel, etc. The computing system 300 may the use the data from the sensors and/or the user devices 314 to determine a probability and timing of usage of an elevator system by such potential passengers.

Typically, advanced elevator dispatching is based on actual elevator requests (e.g., at a kiosk or hall call panel), legacy data records, and/or schedule information. Making predictive elevator dispatching based on user position and movements may be difficult. However, embodiments of the present disclosure are directed to providing predictive elevator dispatching or scheduling based on user position and movement within a building.

For example, in accordance with embodiments of the present disclosure, the probability of a user's intention to request an elevator can be detected by the movements of the user. For example, an accelerometer or magnetometer of a user device of the user may provide movement information that can be processed to determine the likelihood of the user making an elevator call request. The accelerometer may detect motion and movement of the user including standing up, walking, etc. The magnetometer may be used to detect the proximity of the user device to various locations within a building, such as proximity to a magnetic core within a steel structure. Other aspects of the user device may be used to detect position, including connection to various networks, proximity to Bluetooth or other wireless devices, etc. The user device may be a mobile phone or smart phone. It has been observed that certain movements will repeatedly (or habitually) occur when a user intends to call an elevator. For example, when leaving a desk, entering a hallway, and walking toward an elevator, the user may exhibit patterns of movement, position, speed, etc. that are habitual or repeated each time such that these user patterns may be indicative of an elevator call to be made.

A user device having software or applications thereon (e.g., smartphone app) can detect the user movement patterns through the change of sensor data. Historic data of the user movement patterns that precede an elevator call request can be compared. The probability for an elevator call request can be calculated and transmitted to the elevator dispatching system. In some embodiments, the user devices of multiple users can negotiate with each other independently to determine the most probable passenger or sensor raw data that should be transmitted to the dispatcher for calculation. Upon receipt, the elevator dispatching system will incorporate the probability data into the general elevator dispatching programming or data for an optimal distribution of elevators or service scheduling. Multi-sensor data can be used in combination, for example, accelerometer, magnetometer, Bluetooth/Wi-Fi signal strength (from multiple sources), GPS signal availability, cell phone use, etc. can all be used to monitor or determine user movement pattern data.

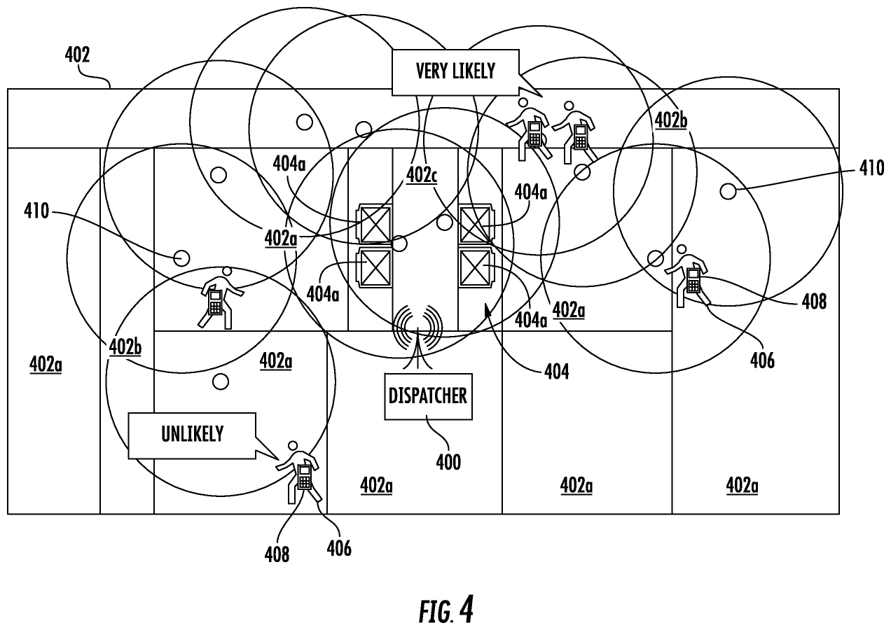

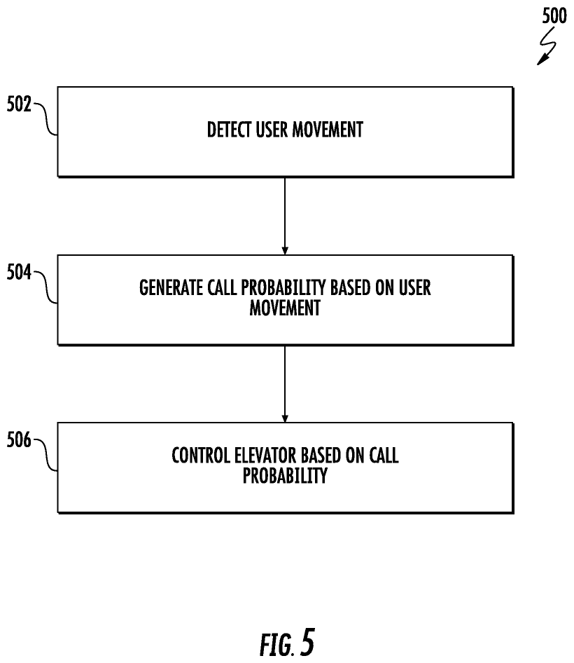

Turning now to FIG. 4, a plan view schematic illustration of a floor 402 of a building illustrating operation of a dispatching system 400 for operation on the floor 402 in accordance with an embodiment of the present disclosure is shown. The floor 402 includes a plurality of rooms 402a, halls 402b, and an elevator landing 402c. The building includes an elevator system 404 that includes one or more elevator cars 404a that provide service to the floor 402 at the elevator landing 402c. The dispatching system 400 may be part of or in communication with an elevator controller to schedule elevator service throughout the building (or amongst a set/subset of floors of a building), including to the floor 402.

As shown, a user 406 may move around the floor 402, and at times may request an elevator at the elevator system 404. The user 406 may carry a user device 408, as described above. A plurality of sensors 410 are located throughout the floor 402 and are arranged to detect the position of the user 406 relative to the elevator system 404. Further, the plurality of sensors 410 are in communication with the dispatching system 400 to provide position information related to the user 406 and thus enable computation of a probability of the user 406 making an elevator call request.

The user device 408 can include various components or elements, as noted above, in order to communicate with a system in accordance with an embodiment of the present disclosure. For example, the user device 408 may include at least one wireless communication device to enable communication with the system. Further, the user device 408 may include one or more user device sensors that are capable of generating data associated with a position and/or movement of the user 406. Such user device sensors may include accelerometers, GPS chips, magnetometers, wireless connection elements, etc., each of which may provide information regarding the position and/or movements of the user 406. That is, the user device 408 and/or the sensors 410 may generate and/or transmit user movement pattern information to the dispatching system 400 to determine a probability that the user 406 will make an elevator call request.

The user movement pattern information may include specific location, such as GPS coordinates or proximity to one of the sensors 410. Further, the user movement pattern information may include information related to the user 406 standing, walking, turning, etc. As such, the user movement pattern information can provide current position and movement information to the dispatching system 400. Based on the user movement pattern information, the dispatching system 400 may anticipate an elevator call request, and thus may park an elevator car 404a appropriately within the elevator system 404 and/or may send an elevator car 404a to the elevator landing 402c such that the elevator car 404a is waiting for the user 406.

It is noted that the dispatching system 400 is based on probability. For example, if the user 406 starts walking toward the elevator system 404, the probability may be relatively high. However, if the user 406 walks past the elevator system 404, such as walking to a different part of the floor 402, the probability may be decreased and/or reduced all the way to zero. It is noted that learning may be applied such that specific movements maybe indicative of an elevator call request. For example, if the user 406 makes specific motions each day when leaving their office for the day, this may indicate, with a high probability, that the user 406 will be desiring to use the elevator system 404. Accordingly, the dispatching system 400 (or a sub-system thereof) may employ machine learning and tracking of user movement pattern information to determine when an elevator call request is most likely, based on user movement pattern information collected in real time or near real time.

In some embodiments, the dispatching system 400 may receive raw data from the sensors 410 and/or the user device 408 and perform processing at the dispatching system 400 to determine a probability of an elevator call request being made. However, in other embodiments, the user device 408 may determine a probability based on data obtained by internal or onboard sensors and/or position information obtained, in part, from interaction with the sensors 410, and transmit a probability to the dispatching system 400. In such configurations, no raw or identifying data may be transmitted, but rather, the dispatching system 400 may merely receive a probability of receiving a call request at the floor 402, and adjust a dispatching or scheduling decision accordingly. It is noted that over time, probability data changes, e.g., based on the location and movement of a user/user device. For example, if a potential passenger forgets an item and turns around after approaching the elevator system, the probability of that potential passenger making a call will be decreased.

Turning now to FIG. 5, a flow process 500 in accordance with an embodiment of the present disclosure is shown. The flow process 500 may be performed as part of an elevator control process, such as scheduling and/or dispatching of elevator cars. Portions of the process may be performed on a user device, at an elevator controller, at a computing system associated with an elevator system, as a remote location (e.g., cloud computing), or one or more combinations thereof.

At block 502, movement by a user is detected. The movement of the user may include data associated with position, speed, direction, estimated time of arrival at an elevator landing, etc., as will be appreciated by those of skill in the art. The detection may be made at the user or remote from the user. For example, a user that is employing the systems described herein will carry a user device (e.g., smartphone or other mobile device), with the position of the user device acting as a proxy for the location and trajectory of the associated user. Such user devices are typically capable of detecting position cues in the environment (e.g., magnetometer readings) and/or being detected by sensors (e.g., near-field communications sensors) in the building. Other position detection means may include GPS, Wi-Fi access point locations, etc. The sensors may be in the user device and data collected by such sensors may be processed either on the user device, in the cloud, or at some other computing device that may receive user position/movement data from the user device. Further, as noted, in some embodiments, sensors may be installed in the building which detect the presence, proximity, or location of the user device to generate the position/movement data.

In accordance with embodiments of the present disclosure, any combination of movement, location, speed, direction, and/or estimated time of arrival at an elevator landing may be employed. It is noted that a time for a potential passenger to reach the elevator landing may be extracted from various movement data. For example, an estimated time of arrival may be synthesized from speed and location, although other methods may be employed without departing from the scope of the present disclosure (e.g., historical data).

At block 504, a call probability is determined or generated based on the movement of the user. The call probability is based on information received from the sensors related to the position and/or trajectory of the user, and the receiving device may be the user device, a remote system, or a combination thereof. The call probability may be generated based on data or information from multiple sensors and may involve a sensor fusion operation including sensors unrelated to the user device (e.g., pressure mat/plate on the floor, light beam, etc.). As noted above, and in some embodiments, the call probability may be based, at least in part, on supervised learning (e.g., trained on rules such as “when someone is within ten feet of the elevator, the probability is 90% . . . ”) or unsupervised learning (e.g., machine learning). In addition, in some embodiments, the call probability may be based, in part, on the quantity or number of users that are detected approaching the elevator system (e.g., three passengers approaching the elevator at 25 feet is more likely going to result in a passenger call than a single passenger). Alternatively, if a plurality of users are approaching the elevator system, the aggregate of the probabilities may be employed to determine a final call probability and thus dispatching or positioning of an elevator car may be made in response thereto.

At block 506, an elevator control system accepts or receives the call probability and makes a supervisory control decision accordingly, e.g., position an elevator car to readily respond to an elevator call made by one of the users. Besides the call probability, the action taken by the elevator controller may depend on how busy the elevator system is, the location of the elevator cars that could respond to the call, customer preferences, etc. The type of action to be taken by the elevator controller may include, but is not limited to, waking up an elevator that is on standby, positioning an available car to a location in anticipation of likely passenger demand, or even calling an elevator on behalf of the passenger in advance of when the passenger reaches the elevator waiting area or hall call panel.

In addition to the above process, systems of the present disclosure may incorporate additional, optional features. For example, the system may employ learning processes to improve the accuracy and/or efficiency of the systems. For example, for each user tracked (and/or each user device tracked), the system can learn through a process of correlating inputs (e.g., position or trajectory of the user) with the outcome (i.e., whether or not the user actually used the elevator). Advantageously, such process can correlate the actual elevator call requests by users with the sensor data collected as above and/or enhanced by sensors in the elevator car. Such learning may be stored within the system (or in the cloud/remotely) to improve over time.

Further, although described herein with respect to a single probability value determining an elevator call and/or adjustments to a scheduling process, various other considerations may be made within the process. For example, in some embodiments, in addition to a probability regarding a potential call, consideration may be applied to an estimated time for the potential passenger to arrive at the elevator system. In some embodiments, the number of potential passengers may also be considered when making scheduling decisions in accordance with embodiments of the present disclosure. Thus, a single probability value may not be the only factor considered in the scheduling analysis and decision making in accordance with embodiments of the present disclosure.

Examples of non-limiting embodiments and operations of the present disclosure are provided herein. The following examples provide illustration of how call probability may be incorporated into elevator scheduling and/or control systems. For example, in a “wakeup” scenario, the elevator system may be in standby mode, which may be used for energy savings as well as reducing wear on the system components. Sensors of the system that are relatively far away from an elevator lobby or landing may detect one or more persons within the building. When such persons are detected by the sensors that are relatively far from the elevator system, the probability of elevator usage may be determined to be low (e.g., about 5%). However, as the persons are detected by sensors closer to the elevator system, the probability may be increased. For example, when one person is detected as approaching an elevator system, the probability may be set to about 70%, and when two or more people are detected by the same sensors, the probably may be set to or determined to be about 90%.

It is noted that there may be a tradeoff between a false positive (e.g., elevator is activated when it is not needed) and a false negative (e.g., not waking up the elevator system when it is actually needed, resulting in a potential longer wait by a passenger). Accordingly, a threshold value or set of values maybe implemented to determine when the elevator should respond to a probability of a call request to be made. For example, the system may be set such that when the probability is greater than 80% the elevator system will respond as if a call request will be made (e.g., wake up, change parked position, etc.). However, as noted above, learning may be implemented by the system, with knowledge of the probability of imminent elevator usage evolving over time, and adjustments to responsive actions and/or thresholds may be made.

Another example of operation of the system may be associated with anticipatory movement of an idle elevator car to be in position to respond to an expected passenger (e.g., a parking position). The system will position an available elevator car based on the probability of an imminent call and may include various other considerations or variables when determining the parking position of an elevator. For example, other considerations may include, but are not limited to, time-frame (e.g., time of day, location of detected persons, etc.), the difficulty of responding to a call (e.g., how far it is to send the car), and the number of passengers affected (e.g., prioritizing a floor which appears to have a larger number of passengers), etc.

In addition to, or as an alternative, the system may be configured to place a call on behalf of a passenger. The probability threshold for placing a call would typically be greater than the probability threshold for a parking operation. Such placed calls, in some embodiments, may be based on time of day, number of detected persons, and historical data. For example, in one such embodiment, the system may place a call for an elevator ride from an upper floor to a lobby/ground floor, at the end of a work day.

Further still, based on detection of persons on a floor of a building, a further action may be to hold an elevator car to wait for an approaching person. In an example of such system, some passengers may have already boarded an elevator car at a floor. Typically, the elevator doors will close and the elevator car may move to a requested next location. However, the present system may enable the detection of an approaching passenger that is sufficiently near the elevator system and with sufficiently high probability of wanting to board the elevator car, and thus may hold the doors open for a few seconds to allow the approaching passenger to board the elevator car.

The above examples and descriptions are merely provided as illustrative operations and functions of systems in accordance with the present disclosure. Various other functions, operations, and processes may be implemented through application of the present disclosure.

Advantageously, embodiments provided herein are directed to predictive elevator scheduling based on movements of users of an elevator system. The predictions may be based on movements and other data associated with positions and/or movements of users. The data may be collected by or from user devices and/or sensors located throughout a building or floor thereof. Based on the collected data, a call probability may be determined such that an elevator scheduling system may appropriately allocate and/or position elevator cars to most efficiently respond to elevator calls.

The systems include a user device that is carried by a user and is able to collect data itself and/or interact with external sensors to generate data associated with the position and/or movements of the user. An elevator controller or other system associated with an elevator controller will receive or calculate a call probability and incorporate such call probability into an elevator scheduling routine. Based on the modified elevator scheduling routine, a dispatch system or elevator controller may adjust the position of one or more elevator cars within an elevator shaft. In some embodiments, the positioning of the elevator cars may be to a parking position, wherein the elevator car is positioned to be ready for an elevator call request made at a hall call panel. In other embodiments, the call probability may be used to generate, in advance, actual elevator call requests, thus eliminating the need for a user to make a call request at a hall call panel.

As discussed above, a call probability is determined based on movements of the users. The probability is merely one input into an elevator scheduling system and thus typically will not be a stand-alone basis for controlling an elevator car to a specific landing. Rather, the call probability will be a factor that is considered with all other typically used data related to elevator scheduling (e.g., time of day, demand/load, etc.). However, in some embodiments, as noted above, the call probability may be used to not only be predictive for scheduling (e.g., parking positions), but may also be used to generate an actual call such that an elevator car may be present at a landing when a user arrives at the landing with the intent to call an elevator car.

The use of the terms “a”, “an”, “the”, and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

1. A method for controlling an elevator system, the method comprising:
at least one of receiving and determining, at an elevator system computing device, a call probability associated with at least one of a movement, a position, a speed, and a direction of a user of the elevator system;
scheduling, with a dispatching system, an elevator car operation based on at least the call probability; and
controlling, with an elevator controller, the operation of an elevator car based on the scheduled elevator car operation.

2. The method of claim 1, wherein the call probability is determined at a user device and transmitted to the elevator computing device.

3. The method of claim 2, wherein the call probability is based on information obtained on the user device.

4. The method of claim 1, further comprising:
sensing at least one of the position and the movement of the user using at least one sensor arranged within a building containing the elevator system; and
transmitting sensed information to the dispatching system.

5. The method of claim 1, further comprising generating an elevator call for the user based on the call probability.

6. The method of claim 1, further comprising performing machine learning and tracking of user movement pattern information of the user to determine the call probability.

7. The method of claim 1, further comprising:
at least one of receiving and determining a call probability associated with at least one of a movement and a position of at least one additional user of the elevator system.

8. An elevator system comprising:
an elevator car;
a plurality of landings; and
an elevator scheduling system comprising:
a processor and memory, wherein the system is configured to:
at least one of generate and receive a call probability associated with at least one of a movement, a position, a speed, and a direction of a user of the elevator system;
schedule an elevator car operation based on at least the call probability; and
control the operation of an elevator car based on the scheduled elevator car operation.

9. The elevator system of claim 8, wherein the call probability is determined at a user device and transmitted to the elevator scheduling system.

10. The elevator system of claim 9, wherein the call probability is based on information obtained on the user device.

11. The elevator system of claim 8, further comprising at least one sensor arranged within a building containing the elevator system, the at least one sensor configured to detect at least one of the position and the movement of the user, wherein the at least one sensor is in communication with the elevator scheduling system.

12. The elevator system of claim 8, wherein the scheduling system is further configured to generate an elevator call for the user based on the call probability.

13. The elevator system of claim 8, wherein the scheduling system is configured to perform machine learning and tracking of user movement pattern information of the user to determine the call probability.

14. The elevator system of claim 8, wherein the scheduling system is further configured to at least one of receive and determine a call probability associated with at least one of a movement and a position of at least one additional user of the elevator system.
